(19) United States
(12) Patent Application Publication
(10) Pub. No.: US 2016/0371695 A1
(43) Pub. Date: Dec. 22, 2016

(54) SYSTEM AND METHOD FOR IDENTITY AND CHARACTER VERIFICATION OF PARTIES TO ELECTRONIC TRANSACTIONS

(71) Applicant: GUARDIAN CONSUMER SERVICES, INC. D/B/A PAVASO, INC., PLANO, TX (US)

(72) Inventors: MARK R. MCELROY, LEWISVILLE, TX (US); JAY HOLLIS, THE COLONY, TX (US); EVANGELIA MOLYVA, ALLEN, TX (US)

(73) Assignee: GUARDIAN CONSUMER SERVICES, INC. D/B/A PAVASO, INC., PLANO, TX (US)

(21) Appl. No.: 14/740,917

(22) Filed: Jun. 16, 2015

(51) Int. Cl. G06Q 20/40

(52) U.S. Cl. CPC G06Q 20/4014

(57) ABSTRACT

Disclosed are systems and methods of verifying the identity and character of parties to an electronic transaction. The system allows an individual person to build an identity verification network of references to verify the identity of, and attest to the character of, that person. The system further facilitates the electronic verification of the identity of at least one party to an electronic transaction by obtaining a visual confirmation score of the identity of that party from references in the party's identity verification network. The system also calculates a character score ranking for assessing the character of a party to an electronic transaction.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

The present invention is directed generally to the field of electronic transactions, and more specifically to systems and methods for verifying the identity and character of parties to electronic transactions.

In the past, business and personal transactions were typically conducted face-to-face, with all parties to a transaction being physically present in the same location. In such face-to-face transactions parties could personally ascertain the identity of the other. Likewise, parties typically knew each other, or could personally engage in prior due diligence to ascertain the reliability and veracity of the other party by, for example, speaking with others who may know that party.

With the advent of computers, however, much of the communication between parties to a transaction, and many of the transactions themselves, have transitioned to being fully or partially reliant on electronic or computer-facilitated communication between parties. For example, email communication has become ubiquitous and most businesses communicate with their customers via email and other electronic communication. Similarly, many transactions, particularly for goods, are instigated and facilitated through the use of electronic communications or ordering systems.

While such electronic communications means are useful, they do have limitations in that the personal knowledge and personal due diligence employed by parties in the past does not translate to modern electronic transactions, where a party's electronic presence has supplemented or replaced its physical presence.

Because of the potential for fraud and abuse in electronic transactions, where parties may have no ability to verify the identity or veracity of the other party, many industries which require high levels of certainty and security, such as the mortgage and insurance industries, have not fully embraced electronic transactions and electronic communications. Instead, those industries still rely primarily on the old face-to-face model of business transactions to verify that a party is who he or she says, and to ascertain the veracity of that party. That reliance greatly limits those businesses' ability to fully serve their customers and potential customers.

Thus, it can be seen that there remains a need in the art for systems and methods to verify the identity and character of parties to electronic transactions.

### BRIEF SUMMARY OF THE INVENTION

The present invention is directed to systems and methods of verifying the identity and character of parties to an electronic transaction. In one aspect of the invention the system allows a person to build an identity verification network of references to verify the identity of, and attest to the character of, that person. In another aspect of the invention, the system facilitates the electronic verification of the identity of at least one party to an electronic transaction by obtaining a visual confirmation of the identity of that party from references in the party's identity verification network. In yet another aspect of the invention, the system builds and maintains a character score ranking for assessing the character of a party to an electronic transaction.

Thus, the system and method of the present invention allows the verification of the identity and a ranking of the character of one or more parties to an electronic transaction.

### BRIEF DESCRIPTION OF THE DRAWINGS

FIG. 1 is a block diagram of a system for verifying the identity and character of a party to an electronic transaction in accordance with an exemplary embodiment of the present invention.

FIG. 2 is a block diagram depicting a detailed view of the identity verification web site of FIG. 1, and depicting exemplary devices used with that system.

FIG. 3 is a diagram of an identity verification network for a consumer maintained by the system of FIG. 1.

FIG. 4A is a diagram of a relationship between a consumer and a reference of the identity verification network of FIG. 3.

FIG. 4B is a process flow diagram of an exemplary request for identity verification processed by the system of FIG. 1.

FIG. 5 is a screen shot of an exemplary ID Validation data input web page in accordance with an exemplary embodiment of the present invention.

FIG. 6 is a screen shot of an exemplary References data input web page in accordance with an exemplary embodiment of the present invention.

FIG. 7 is a diagram of an exemplary identity verification and character score assessment calculated and maintained by the system of FIG. 1.

FIG. 8 is a block diagram of an exemplary method for obtaining an identity verification and character score assessment in conjunction with the system of FIG. 1.

FIG. 9 is a screen shot of an exemplary Score web page in accordance with an exemplary embodiment of the present invention.

### DETAILED DESCRIPTION OF EXEMPLARY EMBODIMENTS

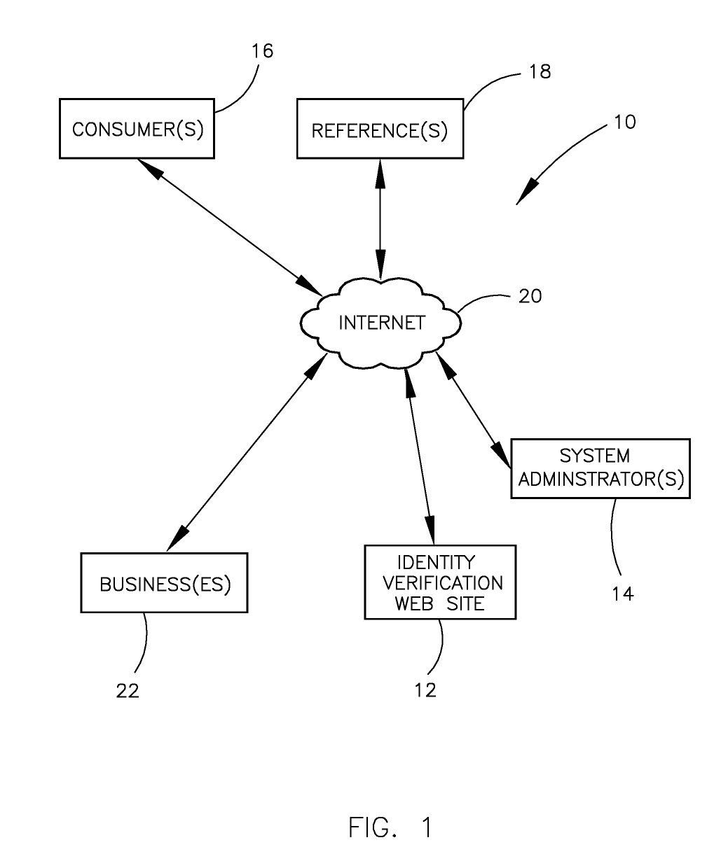

The various aspects described generally above, one or more of which may be incorporated into an identity verification system in accordance with the present invention, will be described in greater detail below with reference to the exemplary embodiments shown in FIGS. 1-6.

While the invention will be described in detail below with reference to various exemplary embodiments, it should be understood the invention is not limited to the specific system configurations or methodologies of these embodiments. For example, although an exemplary embodiment may described the invention used in the context of a mortgage company verifying the identity and character of a customer or potential customer, the present invention may equally be used in other industries and fields, such as an insurance company verifying the identity and character of a consumer, or a consumer verifying the identity and character of a seller of a product on the Internet.

Similarly, while the exemplary embodiments are described with reference to specific access devices, such as personal computers (PCs) or smartphones, it should be understood that other implements and devices capable of performing the necessary communications may equally be used.

These and other variations are contemplated by and within the scope of the present invention. In addition, although the exemplary embodiments are described as embodying several different features, one skilled in the art will appreciate that any one of these features could be implemented without the others, or may be implemented in combinations other than those specifically described, all in accordance with the present invention.

### System

Referring first to FIG. 1, an exemplary system for verifying the identity and character of a party to an electronic transaction in accordance with an exemplary embodiment of the present invention is designated generally by reference numeral 10. System 10 includes an identity verification web site 12 that hosts an application for managing and administering the data and web pages associated with the identity verification and character assessment features of the present invention. Users of the system include one or more system administrators 14 (e.g., entities and/or individuals responsible for maintaining and operating the identity and character verification system, such as an identity verification company), one or more consumers 16 (e.g., individuals seeking the services of a business and desiring to conduct an electronic transaction), one or more references 18 (e.g., individuals known to, or associated with, a consumer), and one or more businesses 20 (e.g., entities providing goods or services to consumers and desiring to verify the identity and character of that consumer).

It should be understood that user groups shown in FIG. 1 may comprise a single user, a plurality of users, or a group of users. For example, a business may be an individual offering services, or may be an entity comprising multiple people and/or locations authorized to conduct business on behalf of the entity. It should also be understood that the particular label associated with an individual may vary depending on the role of that individual in a particular transaction. For example, an individual labeled as a “consumer” with respect to one transaction where that individual is buying goods or services may be labeled as a “business” with respect to another transaction where that individual is selling goods or services. The system and method of the present invention contemplates all of these variations, the particular label associated with an individual with respect to a particular transaction does not affect the verification of identity of that individual or the assessment of the character of that individual as it relates to the present invention.

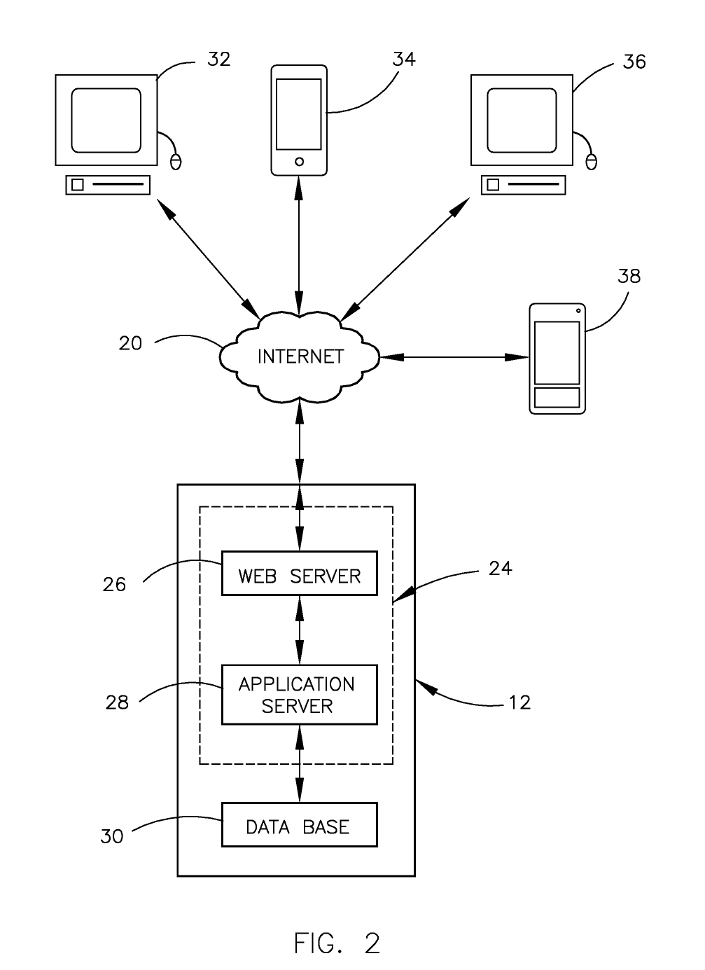

Looking to FIG. 2, an exemplary embodiment of the identity verification website of FIG. 1 is depicted along with exemplary devices employed by users of the system. The identity verification web site 12 includes a server system 24 comprising a web server 26, an application server 28, and a data base server 30, all of which are in communication with each other via any suitable bus or communication system known in the art. One skilled in the art will understand that the configuration of the web site and the hosting arrangement may be varied within the scope of the present invention.

Web server 26 is connected to the Internet 20 and includes a user interface that presents various web pages of the identity verification web site to the users and includes functionality for the users to input data into various data input fields displayed on the web pages and to upload information, such as electronic photographs, to the web site.

The application server 28 executes the identity verification and character assessment application software that provides various types of functionality to the system, such as accepting uploads of photos and/or other information from consumers desiring to establish an electronic identity presence, sending emails to references requesting verification of the identity and character of a consumer, and accepting responses to visual identification questions presented to users. The identity verification and character assessment application may be implemented in different languages, and may comprise groups of programs or subprograms. It should be apparent to one skilled in the art that users are able to utilize the various capabilities of the identity verification and character assessment application via the user interface of the web server 26. Preferably, the identity verification web site is implemented using basic World Wide Web standards for the coding and transmission of hypertext document. These standards include various versions of HTML (hypertext mark-up language) and HTTP (hypertext transfer protocol), including HTML 5 which is suitable for use with mobile devices.

The application server 28 is in communication with the data base server 30, which stores data relating to the various consumers, references, businesses, and system administrator users of the system. For example, visual data in the form of a .jpg (or other known format) comprising an image of a consumer is stored in the data base in association with other data related to that consumer. It should be understood that the database may comprise either a single data base or a plurality of data bases integrated by the ordering and discounting system.

As is known in the art, server system 24 preferably includes one or more processors and one or more memory devices storing instructions which are executed by the one or more processors to perform the specific desired functions. Thus, for example, the processor and memory are in communication via circuitry or hardware as is known in the art, with the processor executing instructions from the memory to perform specific functions, such as serving web pages, receiving information, or other specific and definite functions defined by those executed instructions. The execution of those specific instructions results in a special purpose system defined by the specific instructions executed. The processor(s) may be any microprocessor or computing component or circuitry known in the art. Likewise, the memory device may be any non-transitory memory device known in the art, such as random access memory (RAM), read-only memory (ROM), in the form of memory sticks or cards, flash drives, hard drives, solid-state drives, compact discs (CDs), digital versatile discs (DVDs), Blu-Ray, or other memory devices and technology known in the art.

Users of the system (such as the system administrators 14, consumers 16, references 18, and businesses 22, described above) access the system via the Internet 20 using personal computers 32, 36, tablet computing devices 34, or mobile devices 38 running a web browser application to access the web pages presented by the web server 26. While a typical scenario would include a system administrator 14 accessing the system using a personal computer 32, a consumer accessing the system using a tablet 34 or mobile device 38, and a business accessing the system using a personal computer 36, other configurations and uses of devices by any of the users are contemplated by the present invention. It should be understood that any device capable of running a suitable web browser application may be used by any user to access the system, as is well known in the art.

It should also be understood that the web server 26, application server 28, and data base server 30 may either be co-located or may dispersed across various geographic locations. The present invention also encompasses the deployment of backup servers and parallel servers to increase the traffic handling capabilities of the system. Similarly, while the present invention preferably stores all data in a single database, that database may be backed up or duplicated to other data base servers or RAID drives or may be hosted on various data base servers as is known in the art.

Because the system is hosted and accessed through a standard web browser, users may access the system using common, off-the-shelf computing devices running a web browser application. The user access devices are not required to run any special applications and users are not required to install any appliances or other software modules on their devices in order to use the system.

It should be further understood that while the system is described as being hosted by an identity verification company which offers its services to third party businesses, such as mortgage companies, the system and method of the present invention contemplates other configurations. For example, the system and method of the present invention may be hosted by a mortgage company which uses the identity verification and character assessment itself. Such variations are within the scope of the present invention.

With the configuration of the system set forth, the operation of the system will now be generally described. As just described, the identity verification and character assessment system 10 is accessible by a plurality of users via the Internet 20 using an access device such as a personal computer, tablet, mobile device, smartphone, or other access devices known in the art. Each access device runs a web browser application that enables retrieving, presenting and traversing information resources on the Internet. In particular, a web browser application allows a user's access device to access the web pages of the identity verification. By accessing and interacting with the identity verification web site, the system enables individual consumers to establish an identity verification network of references. The input and data received from the consumers and references builds the identity verification network and allows the system to provide an identity verification and character assessment associated with each consumer. When an individual consumer is a participant in an electronic transaction, the identity verification and character assessment calculated and maintained by the system are made available to the other party to the transaction, providing a level of security and assurance to that other party that the consumer is who he or she says, and providing an assessment of the character of that consumer.

### Identity Verification Networks

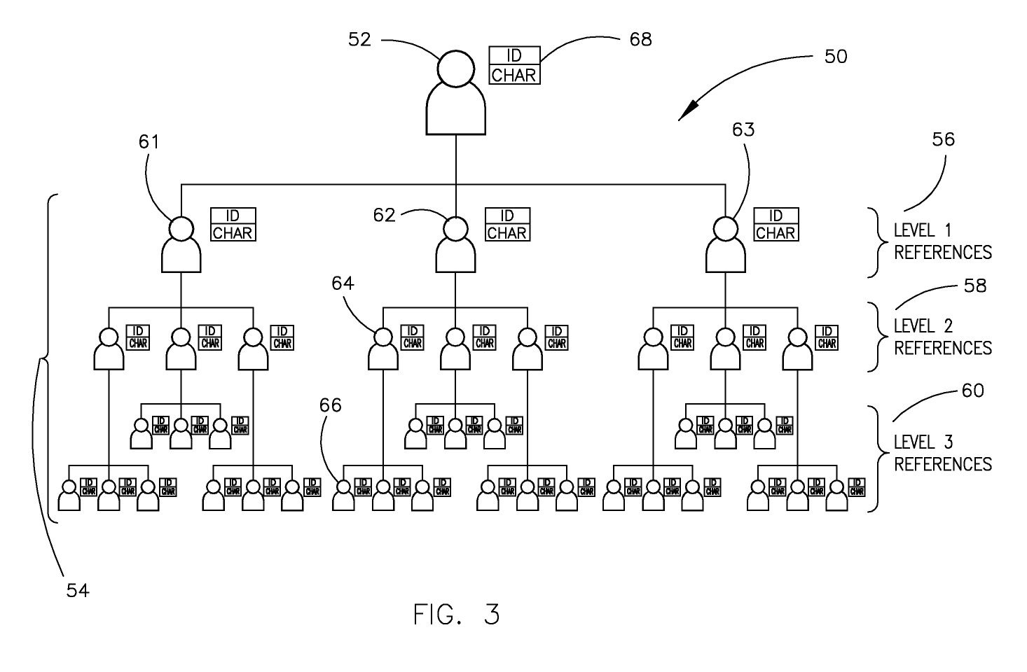

Turning to FIG. 3, an identity verification network is depicted for an individual consumer—i.e., a person seeking to establish an electronic presence and an associated electronic identity verification and character assessment so that they can participate in electronic transactions with businesses employing the identity verification and character assessment system.

As seen in FIG. 3, an identity verification network 50 for an individual person consumer 52 is comprised of a plurality of other individual person references 54 associated with that consumer. Those references are categorized as “Level 1” (56), “Level 2” (58), or “Level 3” (60) references depending upon their relationship to consumer 52. As shown in the figure, a Level 1 reference (e.g., reference 62) is an individual directly known by consumer 52, a Level 2 reference is an individual directly known by a Level 1 reference (e.g., reference 64), and a Level 3 reference (e.g., reference 66) is an individual directly known by a Level 2 reference. References are other individual persons asked to provide verification of the asker's identity and an assessment of the character of that person.

For example, looking still to FIG. 3, consumer 52 has three directly known “Level 1” references (i.e., references 61, 62, and 63). Each of those “Level 1” references also has three directly known (to those “Level 1” individuals) references—those being “Level 2” references with respect to consumer 52. Similarly, each of those “Level 2” references also has three directly known (to those “Level 2 individuals) reference—those being “Level 3” references with respect to consumer 52. Thus, the identification verification network of consumer 52 comprises thirty-nine references: three Level 1 references, nine Level 2 references, and twenty-seven Level 3 references.

As is apparent from FIG. 3, an individual consumer's identity verification network comprises a hierarchy of references—“Level 1” references directly known to that consumer and “Level 2” and “Level 3” references not directly known to that consumer, but ultimately associated with the consumer through the directly-known “Level 1” reference. Thus, an individual consumer's identity verification network comprises the entire group of references, not just references directly known to the consumer.

It should be understood that the identity verification network of FIG. 3 depicts the relationship of references with respect to consumer 52, and that the “Levels” of references described are with respect to consumer 52. It should be further understood that each reference depicted in FIG. 3 may also be an individual consumer having their own network of references. Thus, a corresponding diagram of an identity network for the individual shown as reference 62 would depict that individual as the consumer, with the Level 2 reference 64 being a Level 1 reference with respect to that individual reference 62.

Each individual person depicted in FIG. 3 will thus have their own identity verification network in which they are the consumer, with a plurality of Level 1, Level 2, and Level 3 references comprising that network. Each of those individuals can also appear in others' identity verification networks as a Level 1, Level 2, or Level 3 reference. It should be apparent that there will be overlap between individuals appearing in various networks and that the level of a reference is determined by their association with the consumer in that particular network.

It should be understood that the number of “Level 1,” “Level 2,” and “Level 3” references depicted in the identity verification network of FIG. 3 is exemplary and not limiting. The number of references in any given consumer's identity verification network will vary and grow as additional references join and create their own networks. For example, consumer 52 may initially start with a single “Level 1” reference 62. When reference 62 expands his or her own network, adding reference 64 as a “Level 1” reference, that new reference 64 becomes a “Level 2” reference in the network of original consumer 52. Likewise, the number of levels of references depicted in FIG. 3 is exemplary. As just described, because each reference in original consumer's 52 network may establish their own network, the actual number of levels of references may be much greater than depicted. While the network of the system and method of the present invention depicted in this exemplary embodiment uses three levels of references to establish an identity verification and character assessment for an individual consumer, in alternative embodiments a greater or lesser number of levels may be used. Such variations are within the scope of the present invention.

Looking still to FIG. 3, all thirty-nine individual persons in the consumer's identity verification network (i.e., the thirty-nine references) have an associated identity validation (“ID”) and character assessment score (“CHAR”) 68 that summarizes the input provided by references associated with that individual. The identity validation (“ID”) parameter associated with an individual consumer preferably has two values—“yes” or “no”—indicating whether references of that individual have made a correct visual identification of the individual. The character assessment score “CHAR” parameter is a numerical assessment, scaled from 1 to 25, of the character of the individual consumer. The calculation and scoring of the ID and CHAR parameter by the system will be described in more detail below. It should be understood that an individual consumer's ID (visual identification and verification parameter) and CHAR (character assessment score) are based only upon input from persons who directly know the consumer—i.e., “Level 1” direct references. However, as will be discussed in more detail below, the ID and CHAR parameters of “Level 2” and “Level 3” references are used to rank the strength of the consumer's CHAR score—i.e., “how strongly does the consumer's identity verification network support that CHAR score”?

### Visual Identity Verification

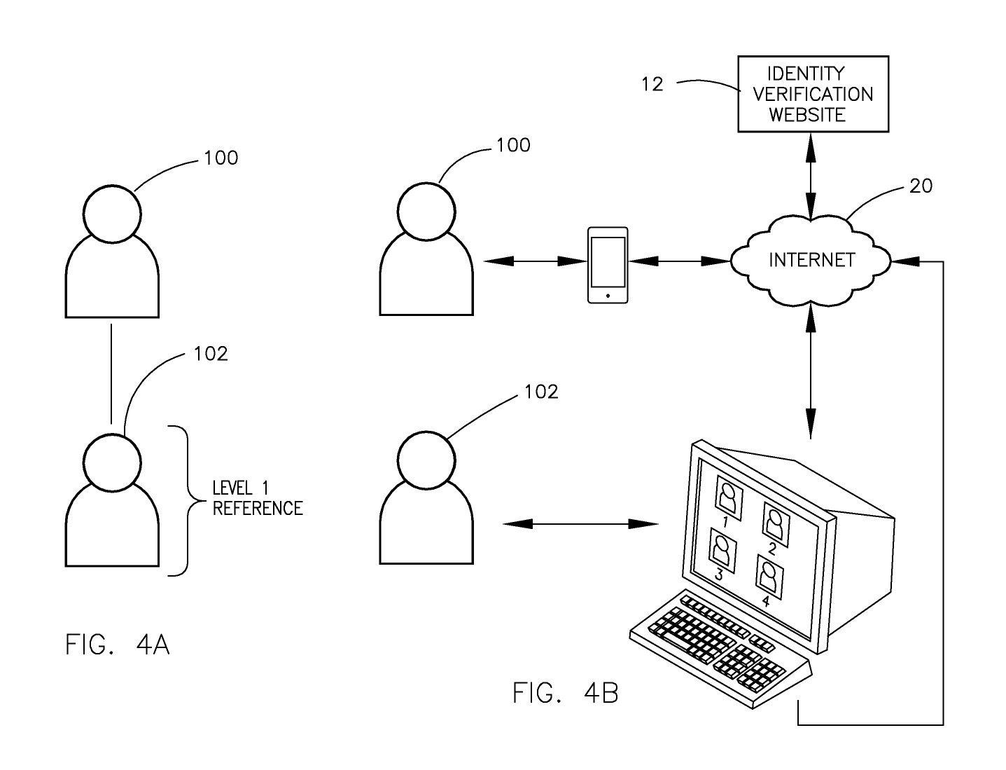

Looking to FIG. 4, an exemplary embodiment of a method of verifying the identity of a consumer in accordance with the present invention is depicted, and will be described with reference to FIGS. 1-3 as discussed above.

As seen in FIGS. 4a and 4b, an individual person consumer 100, desiring to establish an online identity and character score by building an identity verification network as previously described is personally known to another individual person, reference 102. For example, consumer 100 may be applying for a mortgage loan with a business that engages the services of an identity verification company. Or, consumer 100 may desire to begin building an identity verification network in anticipation of applying for a mortgage loan or conducting other electronic transactions. As described previously, identity verification web site 12 allows consumer 100 to establish an account or electronic presence associated with that individual consumer.

Interacting with the identity verification web site 12 using a PC, tablet, smartphone, or other device, consumer 100 provides a photograph, photo identification, or other visual representation of himself, along with his personally identifiable information, such as his name, address, and email address, to the web site. The interaction of consumer 100 with the web site is through web pages served by web server 24 in accordance with the program running on the application server, the web pages present data input fields to allow consumer 100 to upload photographs (i.e., in .jpg or other image format), documents, and to enter information as is known in the art. The data associated with consumer 100 is stored in data base 28 in a record or records associated with consumer 100.

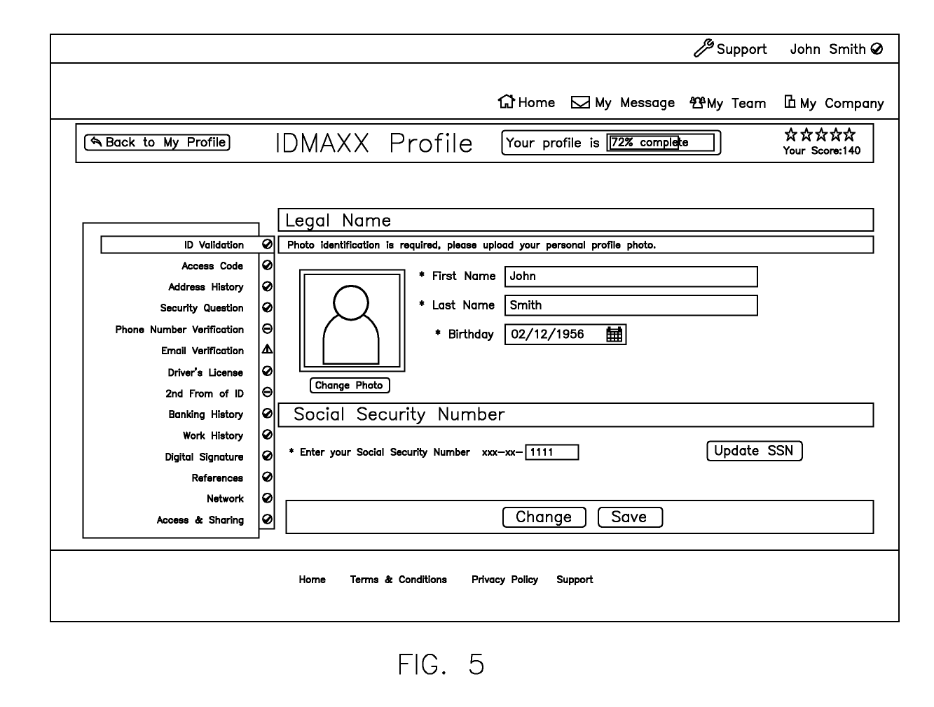

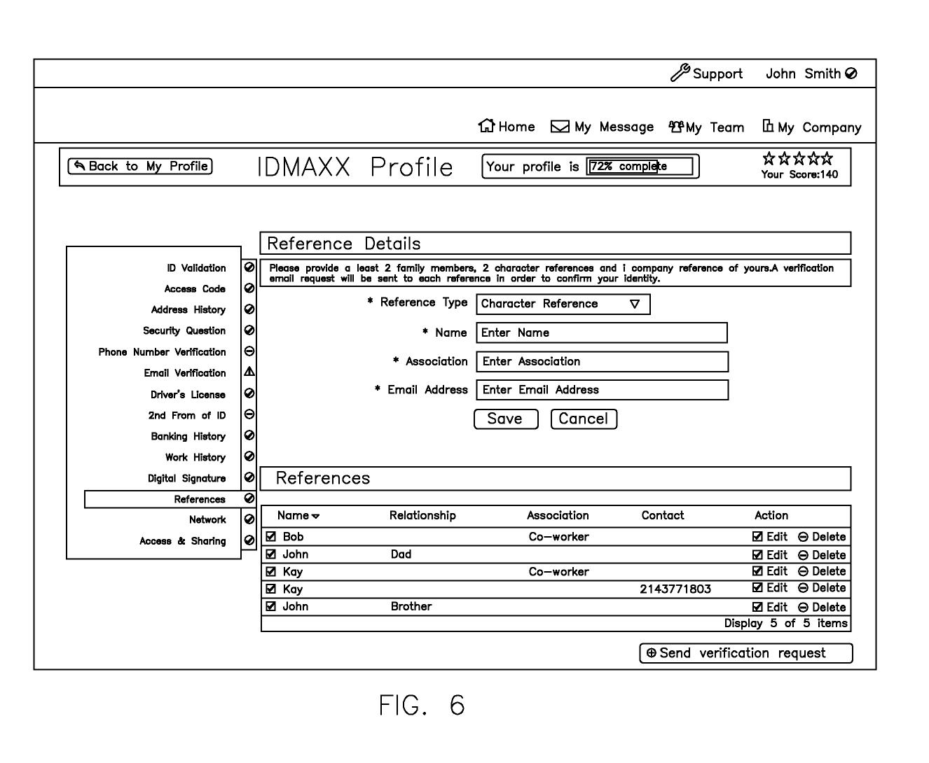

For example, turning to FIGS. 5 and 6, a consumer interacting with the identify verification website enters, uploads, or otherwise provides various identifying information to the website. As seen in FIG. 5, that information includes first and last name, birthdate, social security number, and a photo (uploaded using the “change photo” button presented). In other embodiments of the present invention, other information or other combinations of information associated with identity validation may be requested and entered. As shown in the drop-down menu at the left hand side of the web page depicted in FIG. 5, consumers can also access additional web pages to provide other information, including: selecting an Access Code, providing Address History, setting up a Security Question, providing Phone Number Verification and Email Verification, providing Driver's License information and Second form of ID information, establishing a Banking History, Work History, and Digital Signature, providing References, setting up an identification verification Network, and managing Access and Sharing to the provided information. Thus, each consumer has control over what information is provided to the identity verification website and who has access to that information.

Turning to FIG. 6, an exemplary Reference Details web page is depicted wherein a consumer can establish a network of references and provide information about each. As shown in the figure, a consumer is typically asked to initially provide references of two family members, two character references, and one work reference. As will be described in more detail below, those references will each be sent an email asking them to verify the identity through a visual verification and to provide a ranking or rating of various character traits of the consumer. The input provide by those references will be used to develop a character score associated with that consumer. As seen at the bottom of the depicted web page, each reference associated with that consumer is listed along with their relationship to the consumer, their association with the consumer, and their contact information. The consumer may also edit or delete references from their reference lists using the corresponding edit or delete button.

In addition to his own information and data, consumer 100 provides the email address of an individual known to him, reference 102 (i.e., a “Level 1” reference). In response to receiving the request from consumer 100 and upon receipt of the entered and uploaded photo and/or other information from consumer 100, the identity verification application generates and sends an email to reference 102. The email includes a textual message indicating that consumer 100 has requested that reference 102 become a part of the consumer's identity verification network, and asking reference 102 to visually identify consumer 100 from a lineup of four photos or images generated on an electronic display screen of a computer, tablet, smartphone, or other communications device, one of which images is of consumer 100, three of which are not. Preferably, reference 102 selects the image of consumer 100 by touching the image of the photo on the screen or by entering a number corresponding to the desired image. The electronic selection of the image by user reference 102 may be made using any input mechanism available on the communications device or computer they are using, including a touch sensitive display screen, a mouse, a keyboard, or other selection device.

Upon selection from the lineup of the photo corresponding to consumer 100, the application records a “yes or “Y” verification by reference 102 of the identity of consumer 100, and stores that verification as an ID parameter (as discussed above with respect to FIG. 3) in a data base record associated with consumer 100. Consumer 100 thus has one reference validating his identity, and his identity ranking thus has a value of 1 with each additional correct identification likewise incrementing his identity ranking. An incorrect identification is similarly tracked and incremented.

Preferably, the email generated to reference 102 provides a link to the identity verification web site 12, directing reference 102 to a web page generated by the application, and presenting a photo of consumer 100 along with three other photos of individuals who are not consumer 100. Alternatively, the email itself may include the photo lineup and the selection response of consumer 102 is sent to the identity verification web site and stored as an ID parameter associated with consumer 100.

In addition to requesting reference 102 to visually identify consumer 100, the email preferably includes a series of questions (or a link to a series of questions at the identity verification web site) requesting reference 102 to assess and score the character of consumer 100 by answering a series of questions as will be described in more detail below. The character application records the character score as a “CHAR” parameter (as discussed above with respect to FIG. 3) in a data base record associated with consumer 100.

In a manner similar to that described above with respect to FIG. 3, it can be seen that as consumer 100 adds more people to his network, and/or as more requests to verify the identity of consumer 100 are sent and received, the strength of the ID parameter increases. That is, as more people provide positive visual identification of consumer 100, the value of the ID parameter is incremented accordingly, providing a stronger indication to third parties (e.g., a mortgage company) that consumer 100 is who he says he is.

It should be also be understood that, by accessing the identity verification web site and providing a verification of consumer 100, reference 102 has begun building her own identity verification network in which she is associated with consumer 100.

### Character Assessment

As described above with respect to FIG. 3, each individual within an identity verification network has an associated ID and CHAR parameter, representing their cumulative number of positive identifications by “Level 1” references (ID parameter) and their calculated character assessment score (CHAR), also based on input from “Level 1” references.

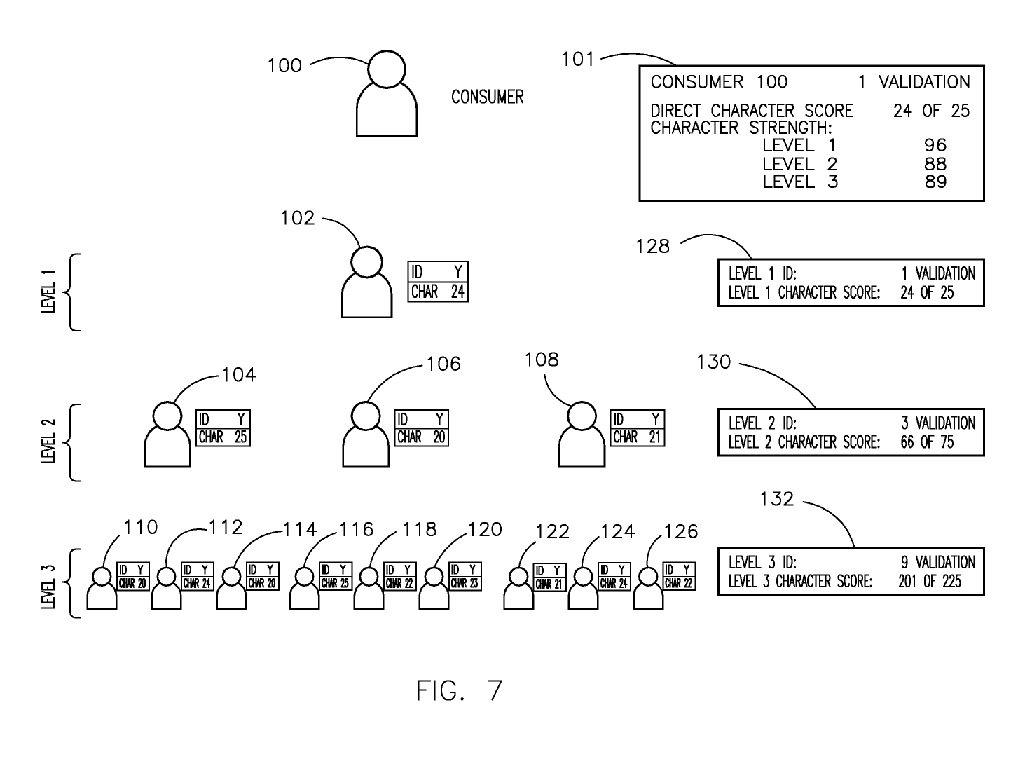

With the calculation of an individual's cumulative visual identification ID parameter described above with respect to FIG. 4, the calculation of an individual's character assessment score CHAR will now be described with respect to FIG. 7. Continuing the example presented with respect to FIG. 4, the identity verification network of consumer 100 includes: one “Level 1” reference (102), three “Level 2” references (104, 106, 108), and nine “Level 3” references (110, 112, 114, 116, 118, 120, 122, 124, 126).

As seen in FIG. 4 and discussed previously, each reference in the consumer 100 identity verification network has an associated visual identity verification parameter (ID) and a character assessment score (CHAR) based on input from direct “Level 1” references to that particular reference as discussed above.

Each entire level of references also has an overall ranking, representing an aggregate of the rankings of each individual reference in that level. For example, referring to FIG. 7, the overall ranking for “Level 3” references is depicted at block 132, with an aggregate ID score of 9 and an aggregate CHAR score of 201 out of 225—the aggregate ID score representing the sum of the ID scores for each of the nine individual references (110, 112, 114, 116, 118, 120, 122, 124, 126) in that level (i.e., 1+1+1+1+1+1+1+1+1=9), and the aggregate CHAR score representing the sum of the CHAR scores for each of those nine individual references (i.e., 20+24 20+25+22+23+21+24+22=201, out of a maximum of 225, as each CHAR score must be in the range of 1 to 25).

Similarly, the aggregate score of the “Level 2” references is ID=3, CHAR=66 out of 75—the sum of the ID and CHAR scores of the three individual references (104, 106, 108) in that level (shown at block 130). Finally, the aggregate score of the “Level 1” references is ID=1, CHAR=24 out of 25—the “sum” of the single individual reference (102) in that level (shown at block 128).

With the aggregate scores for each level of references in the consumer 100 identity verification network determined as just described, the identity verification and character assessment score of consumer 100 are calculated and presented as seen in block 101. As seen in block 101, “Consumer 100” has 1 validation of identity (e.g., ID=1) and a direct character score of 24 of 25. As previously discussed, these scores reflect the input provided by direct, “Level 1” references to consumer 100—in this case, the only “Level 1” reference being reference 102. Of course, if consumer 100 had additional “Level 1” references in his identity verification network, the input of those “Level 1” direct references would be aggregated to arrive at the validation (ID) and direct character score (CHAR) for consumer 100.

Looking still to block 101, in addition to the validation and direct character scores, the scoring of consumer 100 includes a “character strength” parameter representing the aggregate “Level 1,” “Level 2,” and “Level 3” scores discussed above. Each of those aggregate scores (comprised of the sum of the 0 to 25 scores from each reference in that level) is adjusted to a 100 point scale. Thus, the “Level 3” character strength score of 89 shown in block 101 is the representation of the 201 out of 225 aggregate score seen in block 132, which is scaled and truncated to an 89 out of 100 score (i.e., 201/225=0.89333, or 89.3%, truncated to 89 out of 100). Similarly, the “Level 2” character strength score of 88 shown in block 101 is the representation of the 66 of 75 character score shown in block 130 (i.e., 66/75=0.88, which results in a scaled 88 score), and the “Level 1” character strength score of 96 shown in block 101 is the representation of the 24 out of 25 score shown in block 128 (i.e., 24/25=0.96 which results in a scaled 96 score).

The information shown in block 1, including the ID, CHAR, and “Level 1,” “Level 2,” and “Level 3” character strength scores represent the entire identity verification and character assessment score calculated for consumer 100. That score and the underlying information is stored in one or more data base records associated with consumer 100 in a manner similar to that previously described.

The type of questions and the weighting and consideration of the various questions presented to references may permissibly be varied within the scope of the present invention. For example, in one exemplary embodiment, a series of questions in various categories of character traits are presented to a reference with a 0 to 9 scale rating assessment for each question provided by the reference, and a question asking the reference to categorize his or her relationship to the consumer.

TABLE 1

| Categories | Questions | Answers for Questions |
|---|---|---|
| Time | How long have you known this | |
| | person? | |
| Integrity | If this person were to see they | 9, Highly Likely, to |
| | were charged incorrectly at a | zero not very likely |
| | restaurant, what is their | |
| | likelihood of telling them of | |
| | the error? | |
| Reliability | Please rate this person's | 9, Highly Reliable, to |
| | reliability, will they be there | zero not very reliable |
| | when you need them? | |
| Trust- | How would you rate this | 9, very Trustworthy, to |
| worthiness | person's trustworthiness? | zero not trustworthy |
| Relation- | What is your relationship to | Family/Related, Personal, |
| ship | this person? | Military, Work, Civic, |
| | | Business |
| Demeanor | How would you characterize this | 9, Cheerful, zero, Stoic |
| | person's general demeanor? | and unemotional |
| Loyalty | How much do you consider this | 9, Fiercely loyal, to |
| | person to be loyal to the | zero, Whichever the |
| | people around them? | way the wind blows |
| Sincerity | In dealing with this person | 9, Extremely Sincere to |
| | would you rate their | zero, not Sincere |
| | sincerity? | |
| Per- | Is this person generally a | 9, Optimistic, to zero, |
| spective/ | pessimistic or optimistic | Pessimistic |
| Outlook | person? | |

Thus, for example, a reference will establish his or her relationship type with the consumer as: business, civic, family, military, personal, or work. The reference will also indicate how long he or she has known the consumer, preferably in years. The reference will then answer the questions relating to the consumers integrity, reliability, trustworthiness, demeanor, loyalty, sincerity, and perspective on a provided scale, preferably ranging from 0 to 9.

Each reference's responses are preferably weighted according to a predefined schema, such as those shown in Tables 2, 3, and 4, below:

TABLE 2

| Relationship Type | Relationship Weight |
|---|---|
| Business | 100% |
| Civic | 100% |
| Family | 25% |
| Military | 100% |
| Personal | 40% |
| Work | 90% |

As shown in Table 2, the weight given to a reference's input is weighted according to the relationship between the consumer and the reference. Thus, as seen in the table a Family reference's rating is discounted to 25 percent to account for any bias that may be present in that reference's assessment of the consumer. Similarly, a Personal reference's (i.e., a friend of the reference) rating is discounted to 40 percent, again to account for any bias. A Business or Civic reference is not discounted, and is used at 100 percent of the rating provided by the reference. It should be understood that an operator of the system and method of the present invention may establish or alter the weighting given to each relationship type, for example, weighting a Family relationship at 50 percent, or establishing different percentage weighting for any of the relationships as desired. These and other variations are within the scope of the present invention.

TABLE 3

| Relationship Type | <5 YEARS | >5 YEARS |
|---|---|---|
| Business | 90% | 100% |
| Civic | 90% | 100% |
| Family | 90% | 100% |
| Military | 90% | 100% |
| Personal | 90% | 100% |
| Work | 90% | 100% |

As shown in Table 3, a reference's rankings may similarly be weighted based on the length of time the reference has known the consumer, in combination with the relationship type of the reference. Thus, as seen in the table, a reference of any relationship type will have their ranking of a consumer weighted to 90 percent when the reference has not known the consumer for five years or longer. It should be understood from the table that, similar to the percentage weightings discusses previously, that the weightings based on length of time known are preferably set according to the preferences of the operator of the system and method of the present invention. A particular operator may establish three years as a sufficient length of time for a particular reference to have known the consumer to warrant a 100 percent weighting, or may provide various time lengths depending on the relationship between the consumer and the reference. These and other variations are within the scope of the present invention.

TABLE 4

| | |
|---|---|
| Overall | The average, rounded up, of IDMAXX SCORE |
| IDMAXX Score | |
| IDMAXX Score | The reference average multiplied by the Length |
| | Weight multiplied by 100. This is the overall |
| | individual score from the reference answering the |
| | questions. |
| Reference | The average of the individual question scores. |
| Average | |
| Length Weight | A weighting factor determined by whether the |
| | length of the relationship is greater or less than 5 |
| | years. A relationship less than 5 years is worth less |
| | because the person has less experience knowing the |
| | individual. The determination is based on the |
| | reference person answer a question about how long |
| | they knew this person. |
| Weighted | This is an individual score for each category of |
| IDMaxx Cat Score | question. Individual questions being answered fall |
| | into categories. The category score is multiplied by |
| | 100, then multiplied by length weight |
| Category | The category weighted average is intended to |
| Weighted Average | capture a score across all reference types in a |
| | particular category. This is calculated as an |
| | average of the weighted IDMAXX Cat Score. |

As seen in Table 4, the input and rankings provided by a consumer's various references are combined and weighted as described above with respect to Tables 1 through 3. As seen in Table 4, an overall IDMAXX score (i.e., a score associated with a particular consumer) is an aggregation of the various ranking inputs provided by the references, weighted as described above, and combined as described in Table 4. Thus, the entirety of the input provided by the plurality of references is combined to arrive at a single IDMAXX score for that consumer.

### Use of Identity Verification and Character Assessment Score

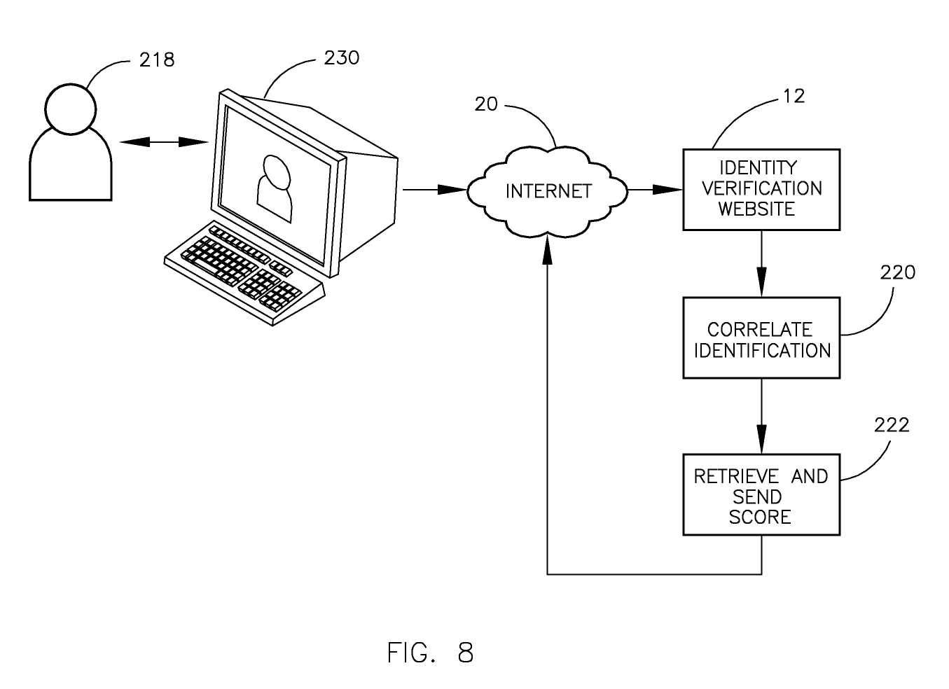

Looking to FIG. 8, and with reference back to FIGS. 1-7, an exemplary use of the identity verification and character assessment score in an electronic transaction with reference to the consumer 100 scores just calculated. A business entity 218, desiring to engage in an electronic transaction with consumer 100 interacts electronically with consumer 100 via a personal computer 230 or other communication device. For example, business entity 218 may offer a mortgage loan to consumer 100. Business entity 218 engages the services of an identity verification company that operates an identity verification web site. As described above, in response to the offer from business entity 218, or by having previously engaged in electronic transactions, consumer 100 establishes an identity verification network of references. Based on the input of those references, the identity verification application calculates ID, CHAR, and character strength scores as described above.

Looking to FIG. 8, upon beginning electronic communication with consumer 100, business entity 218 requests from the identity verification website the identity verification and character assessment score of consumer 100. Upon receipt of the request, the application sends an electronic communication to consumer 100. After receiving approval from consumer 100 to provide the score to business entity 218, the application at block 220 correlates the identification information provided by business entity 218 about consumer 100 with the information the data base has with respect to consumer 100 to ensure that the score to be calculated and provided to business entity 218 is for the correct individual consumer 100. That correlation information may include the consumer's name, email address, physical address, telephone number, and other personally identifiable information.

With the correlation completed, at block 222 the ID, CHAR, and character strength scores for consumer 100 are electronically retrieved and/or calculated by the application, and an electronic report is sent to business entity 218. If the application cannot correlate the individual about which the business entity is asking to the consumer 100 information stored in the data base, an electronic message to that effect is sent to business entity 218 and no scoring information is transmitted.

Upon receipt of the scoring information from the identity verification website, business entity 218 assesses the ID, CHAR, and character strength information to determine if it considers consumer 100 trustworthy so as enter into a loan agreement consumer 100. That assessment and the required scores may vary depending on the business entity. For example, in the case of the customer 100 scores of ID=1, CHAR=24 of 25, and character strength scores of “Level 1”=96, “Level 2”=88, and “Level 3=89” calculated above, a particular business entity may conclude that a single visual identification (ID=1 score) is not high enough. Another business entity, however, may conclude that the high “Level 1” character strength score and the relatively high “Level 2” and “Level 3” character strength scores provide enough assurance of the character of consumer 100 to justify entering into an agreement with that individual consumer. Based on a high number of references in a particular individual's identity verification network, character strength scores of 90 to 100 may be indicative of solid character, scores of 80-89 may be indicative of good character, scores of 70-79 may be indicative of average character, and scores below 70 may be indicative of below average character. Of course, particular business entities may weigh each level of character strength scores and ID and CHAR scores as they choose in assessing an appropriate level of risk for its business model.

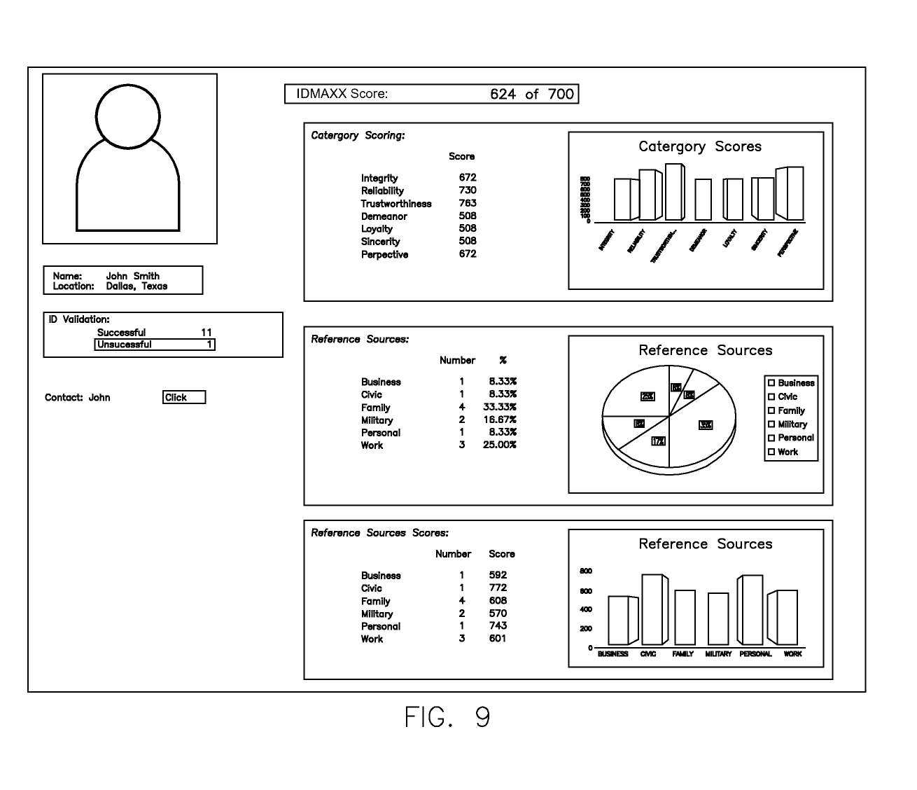

As further described with respect to FIG. 9 and discussed above, the input and specific rankings provided by a plurality of references are weighted and combined into a single IDMAXX score that is associated with the consumer. Looking to FIG. 9, a scorecard for a particular consumer in accordance with an exemplary embodiment of the present invention is depicted. Preferably the scorecard is presented as a web page; alternatively it may be presented as a written report, or as a computer document, such as a Word or Excel file.

As seen in FIG. 9, the scorecard displays the consumer's photograph or image and name, as well as a residence or hometown. A tally of the number of successful and unsuccessful photo identification validations (as discussed above) is depicted under the consumer's image, along with a button allowing contact with the consumer via email as is known in the art.

An overall IDMAXX or character assessment score is presented at the top of the page, that score representing the aggregate total of all references' input and rankings for the consumer, as weighted and combined as described above.

A “Category Scoring” window presents the overall or aggregate score for the consumer in each character assessment category as discussed above. The information is likewise presented in a bar graph format.

A “Reference Sources” window presents a breakdown of the relationship type of the various references contributing to the consumers' score, with a number and overall percentage of each type presented in numerical and pie chart format.

A “Reference Source Scores” provides a view of the aggregate scores for a consumer in each relationship type group, presented in numerical and bar graph format.

Thus, as can be seen in FIG. 9, a user of the system and method of the present invention, desiring to obtain a character assessment of a consumer with which it is engaging in a transaction, can obtain an identity verification and character assessment of that consumer based on the aggregated input of numerous references vouching for and assessing that consumer. For example, looking still to FIG. 9, a user of the system and method can see a photo or image of the consumer and the number of references who positively identified the consumer from a photo lineup as described above. Likewise, a user can see the overall character assessment score for that consumer, as well as breakdown of that score for various categories of character assessment and various groups of references' relationship to the consumer.

As described above, the system and method of the present invention are well-suited to provide identity and character verification of parties to electronic transactions. In accordance with the present invention a consumer, prompted by a business entity desiring to engage in an electronic transaction, or on his own, may establish an electronic presence in the form of an identity verification network, that network comprised of his association with other consumers (or potential consumers) directly known to him, i.e., his references. Those references become part of his network and provide verification of his identity and a rank of his character which are translated to his identity verification score and character assessment score, respectively. As the original consumer adds additional references his network grows, and his identity verification score and character assessment score change based on the input of those additional, directly known, “Level 1” references.

At the same time, as the original consumer's directly known references add references of their own (directly known to the references, but not to the original consumer), the original consumer's network likewise grows, with those additional references being “Level 2” or “Level 3” references to the original consumer—i.e., they are not directly known to the original consumer but reflect on the identity and character of those references who are directly known to the original consumer. Thus, each participant in the network expands the scope and veracity of the original consumer's network by providing additional information and identity verification and character assessment scores to the networks.

A business entity desiring to conduct a transaction with a consumer not directly known to the business entity can thus review the identity verification score and character assessment score of the consumer to ascertain whether it desires to engage in a transaction with the otherwise unknown consumer. The system and method of the present invention thus eliminate the need to provide various physical documents and character references to businesses as is still the practice in many industries.

While the system and method of the present invention have been described herein with reference to various exemplary embodiments, it should be understood that variations to those specific examples are within the scope of the present invention. For example, the identity verification score and character assessment score have been described primarily with respect to a transaction in which a consumer seeks a mortgage loan from a lender. The system and method of the present invention are not restricted to the mortgage lending industry, and the invention described herein may be equally used in any electronic transactions, for example in the insurance industry and any other consumer product and service industries. Likewise, the invention is not restricted to business to consumer transactions. The system and method of the present invention is applicable to electronic transactions between consumers, or between businesses, and is applicable in any transaction where one or more parties desire to obtain information relating to the other party's identity and character when that party is not directly know to them.

Since many possible embodiments may be made of the invention without departing from the scope thereof, it is to be understood that all matters herein set forth or shown in the accompanying drawings are to be interpreted as illustrative, and not in a limiting sense.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A method of verifying the identity of a party to an electronic transaction comprising;
presenting a first plurality of electronic images to a first user, wherein one of said images comprises a likeness of said party and wherein said first user comprises an individual directly known to said party;
receiving a first electronic selection of one of said presented first plurality of images;
incrementing and storing a party selection total corresponding to said party if said first electronic selection corresponds to said image comprising a likeness of said party; and
providing said party selection total as a party identity verification score corresponding to said party.

2. The method of claim 1, wherein said presenting a first plurality of electronic images comprises generating said images on an electronic display.

3. The method of claim 1, wherein said first electronic selection comprises a signal generated by a device selected from the group comprising a touch sensitive display screen, a mouse, a keyboard, a computer, and a communications device.

4. The method of claim 1, further comprising:
presenting at least one question to said first user, said question directed to a character trait of said party;
receiving and storing a response to said at least one question, said response comprising a numerical ranking of said character trait of said party; and
generating and providing a party character assessment score based on said received numerical ranking of said party.

5. The method of claim 1, further comprising:
storing as an identity verification network an association between said party and said first user.

6. The method of claim 1, further comprising:
presenting a second plurality of electronic images to a second user, wherein one of said images comprises a likeness of said first user and wherein said second user comprises an individual directly known to said first user;
receiving a second electronic selection of one of said presented second plurality of images;
incrementing and storing a first user selection total corresponding to said first user if said second electronic selection corresponds to said image comprising a likeness of said first user; and
providing said first user selection total as a first user identity verification score corresponding to said first user.

7. The method of claim 6, further comprising:
presenting at least one question to said second user, said question directed to a character trait of said first user;
receiving and storing a response to said at least one question, said response comprising a numerical ranking of said character trait of said first user; and
generating and providing a first user character assessment score based on said received numerical ranking of said character trait of said first user.

8. The method of claim 7, further comprising:
generating and providing a party character assessment score based on said received numerical ranking of said character trait of said party and said received numerical ranking of said character trait of said first user.

9. The method of claim 1, further comprising:
storing as an identity verification network: (a) an association between said party and said second user and (b) an association between said first user and said second user.

10. A system for verifying the identity of a party to an electronic transaction, comprising:
a processor, and
a memory device storing instructions that, when executed, cause the system to:
present a first plurality of electronic images to a first user, wherein one of said images comprises a likeness of said party and wherein said first user comprises an individual directly known to said party;
receive a first electronic selection of one of said presented first plurality of images;
increment and store a party selection total corresponding to said party if said first electronic selection corresponds to said image comprising a likeness of said party; and
provide said party selection total as a party identity verification score corresponding to said party.

11. The system of claim 10, wherein said presenting a first plurality of electronic images comprises generating said images on an electronic display.

12. The system of claim 10, wherein said first electronic selection comprises a signal generated by a device selected from the group comprising a touch sensitive display screen, a mouse, a keyboard, a computer, and a communications device.

13. The system of claim 10, wherein said computer system is further operable to:
present at least one question to said first user, said question directed to a character trait of said party;
receive and store a response to said at least one question, said response comprising a numerical ranking of said character trait of said party; and
generate and providing a party character assessment score based on said received numerical ranking of said party.

14. The system of claim 10, wherein said computer system is further operable to:
store as an identity verification network an association between said party and said first user.

15. The system of claim 10, wherein said computer system is further operable to:
present a second plurality of electronic images to a second user, wherein one of said images comprises a likeness of said first user and wherein said second user comprises an individual directly known to said first user;
receive a second electronic selection of one of said presented second plurality of images;
increment and store a first user selection total corresponding to said first user if said second electronic selection corresponds to said image comprising a likeness of said first user; and
provide said first user selection total as a first user identity verification score corresponding to said first user.

16. The system of claim 15, wherein said computer system is further operable to:
present at least one question to said second user, said question directed to a character trait of said first user;
receive and store a response to said at least one question, said response comprising a numerical ranking of said character trait of said first user; and
generate and provide a first user character assessment score based on said received numerical ranking of said character trait of said first user.

17. The system of claim 16, wherein said computer system is further operable to:
generate and provide a party character assessment score based on said received numerical ranking of said character trait of said party and said received numerical ranking of said character trait of said first user.

18. The system of claim 17, wherein said computer system is further operable to:
store as an identity verification network: (a) an association between said party and said second user and (b) an association between said first user and said second user.

19. A method of verifying the identity and character of a party to an electronic transaction, comprising:
receiving an electronic request to provide an identity validation and character assessment of a party to an electronic transaction;
retrieving electronic information relating to the identity and character of said party;
correlating at least a portion of said electronic request with said retrieved information to confirm that said information pertains to said party;
transmitting at least one score correlating to an identity of said party and at least one score correlating to a character of said party.

20. The method of claim 19, further comprising:
calculating said at least one score correlating to a character of said party based at least in part on information relating to an identity verification network of said party.

21. The method of claim 20 wherein said calculating said at least one score comprises aggregating data from the group consisting of: at least one individual directly known to said party, and at least one individual not directly known to said party, and combinations thereof.

22. The method of claim 19, wherein said calculating at least one score correlating to an identity of said party comprises aggregating identity verification data from at least one individual directly known to said party.
